(19) United States
(12) Patent Application Publication
(10) Pub. No.: US 2024/0157241 A1
(43) Pub. Date: May 16, 2024

(54) METHOD FOR CONTROLLING GAME SCENE, APPARATUSE, COMPUTER DEVICE, AND STORAGE MEDIUM

(71) Applicant: NETEASE (HANGZHOU) NETWORK CO., LTD., Hangzhou (CN)

(72) Inventor: Xiao WU, Hangzhou, Zhejiang (CN)

(73) Assignee: NETEASE (HANGZHOU) NETWORK CO., LTD., Hangzhou (CN)

(21) Appl. No.: 18/549,592

(22) PCT Filed: Nov. 3, 2022
(86) PCT No.: PCT/CN2022/129462

§ 371 Date: Sep. 8, 2023

(30) Foreign Application Priority Data
Jan. 19, 2022 (CN) 202210060950.8

(51) Int. Cl. A63F 13/5378; A63F 13/52; A63F 13/56

(52) U.S. Cl. CPC A63F 13/5378; A63F 13/52; A63F 13/56; A63F 13/837

(57) ABSTRACT

A method for controlling a game scene includes: displaying a game scene global map of a target game, the game scene global map comprising a plurality of scene regional maps, wherein one of the scene regional maps corresponds to a game scene region of the target game; displaying a target game scene region of one or more target game scene regions of the game scene regions corresponding to a target scene regional map of one or more target scene regional maps of the scene regional maps, in response to an entry trigger operation for the target scene regional map of the scene regional maps; and switching display of the target game scene region to display of the game scene global map, in response to an exit trigger operation for the target game scene region.

The present disclosure claims priority to Chinese Patent Application No. 202210060950.8, filed in the Chinese Patent Office on Jan. 19, 2022, and entitled “METHOD FOR CONTROLLING GAME SCENE, APPARATUSE, COMPUTER DEVICE, AND STORAGE MEDIUM”. The disclosures of the above application are incorporated herein by reference in their entireties.

### TECHNICAL FIELD

The present disclosure relates to game technologies, and more particularly, to methods for controlling a game scene, apparatuses, computer devices, and storage media.

### BACKGROUND

In a game such as a large-world map exploration game, a virtual character controlled by a player can perform behaviours, such as walking, encountering of an event, fighting and the like, on a map with a large physical scale (for example, a map of a continent). With the improvement of quality of mobile phone games and game taste of the player at home, an excellent large-world exploration experience has a strong competitiveness in the market, and is increasingly valued by game research and development manufacturers. However, due to a functional limitation of mobile phone platform hardware, the large-world exploration game has a high requirement for technology and art production capabilities of the manufacturers. Currently, large-world exploration games on the market have poor capability of balancing and considering an artistic effect and display performance and efficiency of the large-world map, resulting in a large load on computing power of a computer device.

### Technical Problem

Embodiments of the present disclosure provide methods for controlling a game scene, apparatuses, computer devices, and storage media, which can solve a problem that a computer device has poor capability of balancing and considering an artistic effect and display performance and efficiency of the large-world map, resulting in a large load on a computing power of a computer device.

### Technical Solutions

In a first aspect, one or more embodiments of the present disclosure provide a method for controlling a game scene, including:
displaying a game scene global map of a target game, the game scene global map comprising a plurality of scene regional maps, wherein one of the scene regional maps corresponds to a game scene region of the target game;
displaying a target game scene region of one or more target game scene regions of the game scene regions corresponding to a target scene regional map of one or more target scene regional maps of the scene regional maps, in response to an entry trigger operation for the target scene regional map of the scene regional maps, wherein after entering the target scene regional, a current virtual character controlled by a player performs game behaviour in the target scene regional map; and
switching display of the target game scene region to display of the game scene global map, in response to an exit trigger operation for the target game scene region.

In a second aspect, one or more embodiments of the present disclosure further provide an apparatus for controlling a game scene, including:
a first display unit configured to display a game scene global map of a target game, the game scene global map comprising a plurality of scene regional maps, wherein one of the scene regional maps respectively corresponds to a game scene region of the target game;
a second display unit configured to display a target game scene region of one or more target game scene regions of the game scene regions corresponding to a target scene regional map of one or more target scene regional maps of the scene regional maps, in response to an entry trigger operation for the target scene regional map of the scene regional maps, wherein after entering the target scene regional, a current virtual character controlled by a player performs game behaviour in the target scene regional map; and
a switching unit configured to switch display of the target game scene region to display of the game scene global map, in response to an exit trigger operation for the target game scene region.

Optionally, the game scene global map includes a plurality of entry controls respectively corresponding to the scene regional maps. The second display unit is further configured to:
determine a scene regional map of the scene regional maps corresponding to a target entry control as the target scene regional map, in response to a touch operation on the target entry control of the entry controls; and
obtain the target game scene region corresponding to the target scene regional map, and display the target game scene region.

Optionally, the first display unit is further configured to:
display the current virtual character in the game scene global map.

The second display unit is further configured to:
control the current virtual character to enter the target game scene region from the game scene global map; and
control the current virtual character to perform the game behaviour in the target game scene region.

Optionally, the switching unit is further configured to:
switch display of the target game scene region to display of the game scene global map, and control the current virtual character to leave the target game scene region and return to the game scene global map, in response to the exit trigger operation for the target game scene region.

Optionally, the second display unit is further configured to:
obtain a switching position of the current virtual character in the game scene global map when entering the target game scene region from the game scene global map.

The switching unit is further configured to:
control the current virtual character to leave the target game scene region and return to the switching position in the game scene global map.

Optionally, the target game scene region has an entry position and an exit position. The second display unit is further configured to:
after entering the target game scene region, control the current virtual character to be located at the entry position of the target game scene region; and
in response to a movement control operation for the current virtual character, control the current virtual character to move in the target game scene region from the exit position of the target game scene region.

The switching unit is further configured to:
in response to the movement control operation for the current virtual character, if the current virtual character moves to the exit position, switch display of the target game scene region to display of the game scene global map.

Optionally, the second display unit is further configured to:
control the current virtual character to enter the target game scene region; and
in response to a game fight joining operation for the virtual character in the target game scene region, control the virtual character to join a game fight in the target game scene region.

The switching unit is further configured to:
in response to a game operation for the virtual character in the game fight, if the game fight ends, switch display of the target game scene region to display of the game scene global map.

Optionally, the second display unit is further configured to:
obtain region attribute information of each of the scene regional maps in the game scene global map; and
display the region attribute information corresponding to each of the scene regional maps in a preset range of each of the scene regional maps in the game scene global map.

Optionally, the second display unit is further configured to:
in response to selection operations respectively for the target scene regional maps in the game scene global map, determine a selection order in which the target scene regional maps are selected, as an order in which a current virtual character enter the target game scene regions; and
switch display of the game scene global map to display of one of the target game scene regions corresponding to the first selected target scene regional map in the selection order.

The switching unit is further configured to:
in response to the exit trigger operation for a currently displayed target game scene region of the target game scene regions, in response to determining that the currently displayed target game scene region corresponds to the last selected target scene regional map based on the selection order, switch display of the currently displayed target game scene region to display of the game scene global map; and
in response to determining that the currently displayed target game scene region does not correspond to the last selected target scene regional maps, switching display of the currently displayed target game scene region to display of one of the target game scene regions next to the currently displayed target game scene region based on the selection order.

Optionally, the game scene global map comprises a global map element, the game scene region includes a regional map element, the global map element includes a reference map element corresponding to the regional map element, and a position of the reference map element in the game scene global map is used to represent a position of the regional map element in the game scene region.

Optionally, the game scene global map includes a satellite map of all game scenes of the target game.

In a third aspect, one or more embodiments of the present disclosure further provide a computer device, including:
a memory, configured to store computer programs; and
a processor, configured to execute the computer programs to perform operations of the method for controlling the game scene.

In a fourth aspect, one or more embodiments of the present disclosure further provide a computer-readable storage medium storing computer programs executed by a processor to perform operations of the method for controlling the game scene.

### BENEFICIAL EFFECTS

Embodiments of the present invention provide methods for controlling a game scene, apparatuses, computer devices, and storage media. When a player starts a target game, the computer device first displays a game scene global map of the target game. When the player wants to enter a certain region included in the game scene global map to perform a game behaviour, the player may perform an entry triggering operation on a target scene regional map in a plurality of scene regional maps, and the computer device displays a target game scene region corresponding to the target scene regional map. When the player performs an exit triggering operation, the computer device switches the target game scene region to the game scene global map. By displaying the game scene global map and the target game scene region of a small area of the target game, an overall element of the game scene global map is displayed macroscopically and a detail element of a specific game scene region is displayed microscopically in a game process, which improves balance and overall consideration capabilities of the computer device for an art effect and display performance and efficiency of large-world maps and reduces an amount of a content displayed by the computer device and a computing power load of the computer device.

### BRIEF DESCRIPTION OF THE DRAWINGS

To describe technical solutions in the embodiments of the present disclosure more clearly, accompanying drawings required for describing the embodiments will be introduced briefly. It is apparent that the accompanying drawings in the following description are merely embodiments of the present disclosure, and other drawings may be obtained according to these drawings by those skilled in the art without involving any inventive effort.

FIG. 1 is a schematic diagram illustrating a system with an apparatus for controlling a game scene according to one or more embodiments of the present disclosure.

FIG. 2 is a schematic flow chart of a method for controlling a game scene according to one or more embodiments of the present disclosure.

FIG. 3 is a schematic diagram illustrating entry controls according to one or more embodiments of the present disclosure.

FIG. 4 is another schematic flow chart of a method for controlling a game scene according to one or more embodiments of the present disclosure.

FIG. 5 is a schematic block diagram of an apparatus for controlling a game scene according to one or more embodiments of the present disclosure.

FIG. 6 is a schematic block diagram of a computer device according to one or more embodiments of the present disclosure.

### DETAILED DESCRIPTION

Technical solutions in the embodiments of the present disclosure will be clearly and completely described below in connection with the accompanying drawings in the embodiments of the present disclosure. It is apparent that the described embodiments are only part of embodiments of the present disclosure, and not all embodiments thereof. Based on the embodiments in the present application, all other embodiments obtained by a person having skill in the art without any inventive effort fall within the protection scope of the present application.

Embodiments of the present disclosure provide methods for controlling a game scene, apparatuses, computer devices, and storage media. Specifically, the methods for controlling the game scene of the embodiments of the present disclosure may be performed by a computer device, which may be a terminal, a server, or the like. The terminal may be a smartphone, a tablet computer, a notebook computer, a touch screen, a game machine, a Personal Computer (PC), a Personal Digital Assistant (PDA), or the like. The terminal may also include a client, which may be a game application client, a browser client with a game program, an instant messaging client, or the like. The server may be a separate physical server, may be a server cluster or a distributed system composed of multiple physical servers, or may be a cloud server providing basic cloud computing services such as cloud services, cloud databases, cloud computing, cloud functions, cloud storage, network services, cloud communications, middleware services, domain name services, security services, content distribution network services, and big data and artificial intelligence platforms.

For example, when the methods for controlling the game scene runs on the terminal device, the terminal device stores a game application and is configured to present a scene in a game screen. The terminal device is configured to interact with a player through a game interface, for example, by downloading, installing, and running the game application on the terminal device. The terminal device provides the game interface to the player through a plurality of ways. For example, the game interface may be rendered for display on a display screen of the terminal device, or may be presented by holographic projection. For example, the terminal device may include a touch screen and a processor. The touch screen is configured to present the game interface and receive an operation instruction generated by the player on the game interface. The game interface includes a virtual scene. The processor is configured to run the game application and a game, generate the game interface, respond to the operation instruction, and control a display of the game interface on the touch screen.

For example, when the methods for controlling the game scene are performed by the server, it may be a cloud game. The cloud game refers to a game based on cloud computing. In an operation mode of the cloud game, an operation subject of the game application and a display subject of the game interface are separated, and storage and operation of the methods for controlling the game scene are performed on a cloud game server. A display of the game interface is performed at a client of the cloud game. The client of the cloud game client is mainly used for receiving and transmitting game data and presenting the game interface. For example, the client of the cloud game may be a display device having a data transmission function near a player side, such as a mobile terminal, a television, a computer, a palmtop computer, or a personal digital assistant, but the terminal device for processing game data is a cloud game server on a cloud side. When playing the game, the player operates the cloud game client to send the operation instruction to the cloud game server, and the cloud game server runs the game application according to the operation instruction, encodes and compresses data such as the game interface, returns the data to the client of the cloud game through the network, and finally decodes the data and outputs the game interface through the client of the cloud game.

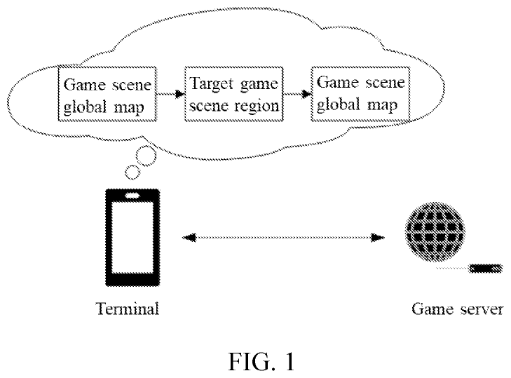

Referring to FIG. 1, FIG. 1 is a schematic diagram illustrating a system of an apparatus for controlling a game scene according to one or more embodiments of the present disclosure. The system may include at least one terminal device and at least one game server. The terminal device held by a user may be connected to the game server(s) of different games through different networks. The network may be a wireless network or a wired network. For example, the wireless network is a wireless local area network (WLAN), a local area network (LAN), a cellular network, a 2G network, a 3G network, a 4G network, a 5G network, or the like. The terminal device is configured to: display a game scene global map of a target game, the game scene global map including a plurality of scene regional maps, wherein one of the scene regional maps corresponds to a game scene region of the target game; display a target game scene region of one or more target game scene regions of the game scene regions corresponding to a target scene regional map of one or more target scene regional maps of the scene regional maps, in response to an entry trigger operation for the target scene regional map of the scene regional maps, wherein after entering the target scene regional, a current virtual character controlled by a player performs game behaviour in the target scene regional map; and switch display of the target game scene region to display of the game scene global map, in response to an exit trigger operation for the target game scene region. The game server is configured to provide game data relating to a game interface such as the game scene global map and the target game scene region.

Detailed descriptions are given below. It should be noted that an order in which the following embodiments are described is not intended to limit a preferred order of the embodiments.

The embodiments will be described from the perspective of an apparatus for controlling a game scene, which may be specifically integrated in the terminal device. The terminal device may include devices such as a smartphone, a notebook computer, a tablet computer, and a personal computer.

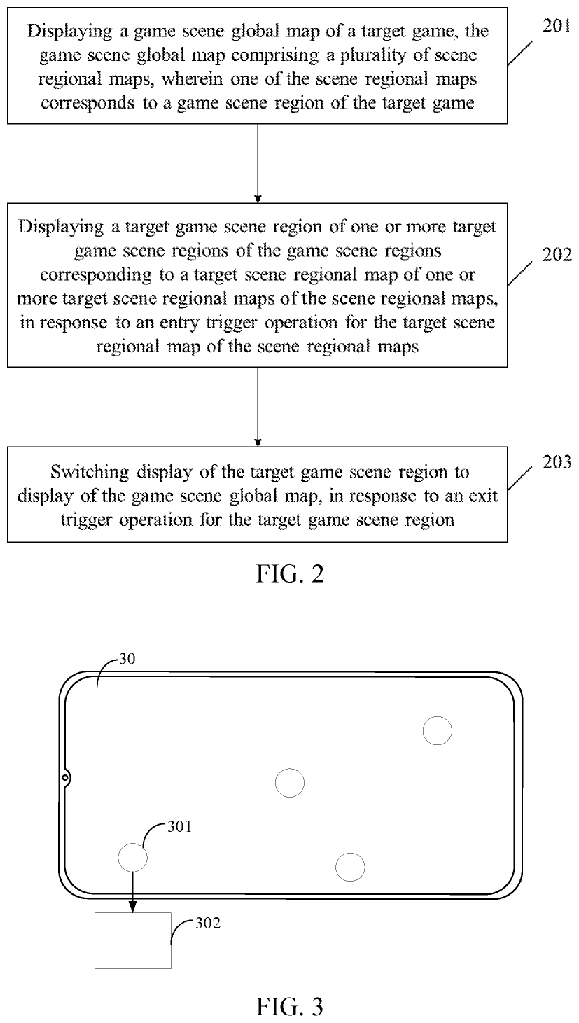

A method for controlling a game scene is provided according to one or more embodiments of the present disclosure. The method may be executed by a processor of a terminal. As shown in FIG. 2, a specific flow of the method for controlling the game scene mainly includes operations 201 to 203, which are described in detail as follows.

In operation 201, a game scene global map of a target game is displayed, the game scene global map including a plurality of scene regional maps, wherein one of the scene regional maps corresponds to a game scene region of the target game.

In the embodiments of the present disclosure, the target game may be a first person shooter game, a third person shooter game, a multi-person online role-playing game, or the like. The terminal stores a game application, receives game data of the target game sent by a game server after running the game application, forms a game interface including the game scene global map, and provides the game interface to a player. The game interface refers to an interface corresponding to an application provided or displayed through a graphical user interface, and the interface includes a user interface (UI) and a game screen for interaction with the player. In an alternative embodiment, the UI may include game controls (e.g., skill controls, movement controls, function controls), indication identifiers (e.g., direction indication identifiers, character indication identifiers), information display regions (e.g., a number of kills, game time), or game settings controls (e.g., system settings, a store, virtual currency).

In the embodiments of the present disclosure, the game scene global map includes an entire scope of a virtual scene of the target game. The terminal device can display the game scene global map which is clear and has a good artistic effect. However, in order to reduce a computing power load of the terminal device, the terminal device may also display the game scene global map with lower definition and a poor artistic effect. That is, outlines of virtual objects (e.g., forest vegetation or mountains) are displayed in the game scene global map, which reflect magnificence of the virtual scene.

In the embodiments of the present disclosure, the game scene global map may be a satellite map of all game scenes of the target game. That is, in the satellite map, green grassland vegetation on the ground is represented in large pieces of green, and small regions of red flowers grown at intervals of the grassland vegetation are not displayed in the satellite map. Outlines of high and lofty mountain peaks, main building groups, and the like are shown. Since the mountain peaks are larger than buildings, in the satellite map, a volume of the main building group contrasts with a volume of the mountain peaks.

In the embodiments of the present disclosure, a scene regional map refers to a scene map of a partial region in the game scene global map, and a game scene region refers to a specific game virtual scene of the scene regional map. The virtual objects (e.g., trees, tall buildings, lawns) displayed in the game scene region have a high definition and are comparatively specific, and the virtual objects in the game scene can be seen at close distances. For example, a small range of grassland vegetation may be displayed in the game scene region. On the grassland vegetation, a shape of each blade of small grass may be seen, shapes of scattered red florets growing in grassland may be displayed, and scattered metal fragments on the grassland may also be seen.

For example, the game scene global map is a satellite map of all island scenes. The island scenes may include various specific scene regional maps such as a hospital region, a training field region, and a seawater region. A hospital building virtual scene corresponding to the hospital region is the game scene region.

In the embodiments of the present disclosure, because the scene regional map is a local region in the game scene global map, corresponding regions in the game scene regional map and the game scene global map have a same region structure. Specifically, the game scene global map includes a global map element, the game scene region includes a regional map element, the global map element includes a reference map element corresponding to the regional map element, and a position of the reference map element in the game scene global map is used to represent a position of the regional map element in the game scene region. The global map element is a specific virtual object (e.g., a virtual valley, a virtual river) in the game scene global map. The regional map element is a specific virtual object (e.g., a virtual building, a virtual road) in the scene regional map. For example, if the game scene global map is an island map and the scene regional map is a hospital regional map in the island map, the global map element may be a hospital building group, a training field building group, a seawater region, or the like in the island map, and the regional map element may be every specific building in the hospital. If the hospital building group is adjacent to the training field building group in the island map, the hospital building group and the training field building group are the reference map element(s), and in the game scene region corresponding to the scene regional map, not only every specific building in the hospital is displayed, but also the training field building group may also be displayed at a distance.

In the embodiments of the present disclosure, a current virtual character controlled by the player may be displayed in the game scene global map. That is, after the operation 201 of displaying the game scene global map of the target game, the current virtual character is displayed in the game scene global map. That is, when the player enters the target game, the current virtual character initially appears in the displayed game scene global map, and the player can control the current virtual character to move in the game scene global map.

In operation 202, a target game scene region of one or more target game scene regions of the game scene regions corresponding to a target scene regional map of one or more target scene regional maps of the scene regional maps are displayed in response to an entry trigger operation for the target scene regional map of the scene regional maps. After entering the target game scene region, the current virtual character controlled by the player performs a game behaviour in the target game scene region.

In the embodiments of the present disclosure, since a scene in the game scene global map is relatively abstract and large, and a game scene in the game scene region is relatively specific, the current virtual character controlled by the player may be controlled to perform the game behaviour in the game scene region. For example, the game behaviour may be behaviours of the current virtual character such as moving in the game scene region, participating in a game fight, watching the game fight, picking up a game virtual resource, or the like.

In the embodiments of the present disclosure, the game scene global map includes a plurality of entry controls respectively corresponding to the game scene regional maps. The player may enter a specific game scene region through interacting with the entry controls. Specifically, the operation 202 of displaying the target game scene region of the one or more target game scene regions of the game scene regions corresponding to the target scene regional map of the one or more target scene regional maps of the scene regional maps in response to the entry trigger operation for the target scene regional map of the scene regional maps may include:
determining a scene regional map of the scene regional maps corresponding to a target entry control as the target scene regional map, in response to a touch operation on the target entry control of the entry controls; and
obtaining the target game scene region corresponding to the target scene regional map, and displaying the target game scene region.

For example, referring to a schematic diagram illustrating entry controls as shown in FIG. 3, the game scene global map 30 includes a plurality of entry controls, each of which corresponds to one game scene region. An entry control 301 corresponds to a game scene region 302. When the player performs a touch operation on the entry control 301, the terminal switches the game scene global map 30 to the game scene region 302.

In one embodiment of the present disclosure, if the current virtual character initially appears in the game scene global map, and after the terminal displays the target game scene region, the current virtual character may be controlled to be displayed in the target game scene region, so that the current virtual character performs the game behaviour in the target game scene region. Specifically, after the operation 202 of displaying the target game scene region of the one or more target game scene regions of the game scene regions corresponding to the target scene regional map of the one or more target scene regional maps of the scene regional maps in response to the entry trigger operation for the target scene regional map of the scene regional maps, the method further includes:
controlling the current virtual character to enter the target game scene region from the game scene global map, and
controlling the current virtual character to execute the game behaviour in the target game scene region.

In the embodiments of the present disclosure, region attribute information (e.g., a region terrain, a region name, activities held in a region, a game fight occurring in a region, a virtual object that can be attacked in a region) of different scene regional maps may be displayed in the game scene global map, so that the player can select the target scene regional map to enter according to the region attribute information. Specifically, before the operation 202 of displaying the target game scene region of the one or more target game scene regions of the game scene regions corresponding to the target scene regional map of the one or more target scene regional maps of the scene regional maps in response to the entry trigger operation for the target scene regional map of the scene regional maps, the method may include:
obtaining the region attribute information of each of the scene regional maps in the game scene global map; and
displaying the region attribute information corresponding to each of the scene regional maps in a preset range of each of the scene regional maps in the game scene global map.

In the embodiments of the present disclosure, a size of the preset range is not limited and a display form of the region attribute information is not limited.

In operation 203, display of the target game scene region is switched to display of the game scene global map, in response to an exit trigger operation for the target game scene region.

In the embodiments of the present disclosure, if the current virtual character is initially in the target game scene region, when the target game scene region is displayed, the current virtual character enters the target game scene region from the game scene global map. When the target game scene region is switched to the game scene global map, the current virtual character may be controlled to return to the game scene global map. Specifically, the operation 203 of switching display of the target game scene region to display of the game scene global map in response to the exit trigger operation for the target game scene region may include: switching display of the target game scene region to display of the game scene global map, and controlling the current virtual character to leave the target game scene region and return to the game scene global map, in response to the exit trigger operation for the target game scene region.

In the embodiments of the present disclosure, the current virtual character enters one of the target game scene regions from the game scene global map, and when the one of the target game scene regions is switched to the game scene global map, the current virtual character may be controlled to return to a position in the game scene global map wherein the current enters the one of target game scene region. Specifically, after the operation of controlling the current virtual character to enter the target game scene region from the game scene global map, the method further includes: obtaining a switching position of the current virtual character in the game scene global map when the current virtual character enters the target game scene region from the game scene global map. At this time, the operation of controlling the current virtual character to leave the target game scene region and return to the game scene global map includes: controlling the current virtual character to leave the target game scene region and return to the switching position in the game scene global map.

In the embodiments of the present disclosure, after the current virtual character enters the target game scene region, it may be set that after the current virtual character satisfies a preset game behaviour condition, the player may execute the exit trigger operation, which switches the target game scene region to the game scene global map, and controls the current virtual character to return to the game scene global map. The preset game behaviour condition is not limited, and may be flexibly set according to actual conditions. For example, the preset game behaviour condition may be set as the current virtual character moving from the entry position to the exit position in the target game scene region, may be set as the current virtual character completing the game fight, or may be set as the current virtual character obtaining a target virtual resource in the target game scene, or the like.

In the embodiments of the present disclosure, when the preset game behaviour condition is set as the current virtual character moving from the entry position to the exit position in each of the target game scene region, the target game scene region includes the entry position and the exit position. At this time, after the operation 202 of displaying the target game scene region of the one or more target game scene regions of the game scene regions corresponding to the target scene regional map of the one or more target scene regional maps of the scene regional maps in response to the entry trigger operation for the target scene regional map of the scene regional maps, the method may include: after entering the target game scene region, controlling the current virtual character to be located at the entry position of the target game scene region; and in response to a movement control operation for the current virtual character, controlling the current virtual character to move in the target game scene region from the entry position. The operation 203 of switching display of the target game scene region to display of the game scene global map in response to the exit trigger operation for the target game scene region may include: in response to the movement control operation for the current virtual character, if the current virtual character moves to the exit position, switching display of the target game scene region to display of the game scene global map.

In the embodiment of the present disclosure, when the preset game behaviour condition is set as the current virtual character completing the game fight, after the operation 202 of displaying the target game scene region of the one or more target game scene regions of the game scene regions corresponding to the target scene regional map of the one or more target scene regional maps of the scene regional maps in response to the entry trigger operation for the target scene regional map of the scene regional maps, the method further includes: controlling the current virtual character to enter the target game scene region; and in response to a game fight joining operation for the current virtual character in the target game scene region, controlling the current virtual character to join the game fight in the target game scene region. The operation 203 of switching display of the target game scene region to display of the game scene global map in response to the exit trigger operation for the target game scene region may include: in response to a game operation for the current virtual character in the game fight, if the game fight ends, switching display of the target game scene region to display of the game scene global map.

In the embodiments of the present disclosure, the player may select one target scene regional map at a time, so that the terminal switches from the game scene global map to the target scene regional map. When the player performs the exit trigger operation, the terminal switches from the target game scene region to the game scene global map. When the player wants to execute a plurality of entry trigger operations continuously to enter a plurality of scene regional maps continuously at one time while avoiding a plurality of decentralized execution of the plurality of entry trigger operations, in order to avoid that the player returns to the game scene global map after executing the exit trigger operation for each target game scene region, the player may be set to directly enter a next selected target game scene region after executing the exit trigger operation for a previous target game scene region.

Specifically, the operation 202 of displaying the target game scene region of the one or more target game scene regions of the game scene regions corresponding to the target scene regional map of the one or more target scene regional maps of the scene regional maps in response to the entry trigger operation for the target scene regional map of the scene regional maps includes:
in response to selection operations respectively for the one or more target scene regional maps in the game scene global map, determining a selection order in which the one or more target scene regional maps are selected, as an order in which the current virtual character is to enter the target game scene regions; and
switching display of the game scene global map to display of the target game scene region corresponding to the first selected target scene regional map in the selection order.

At this time, the operation 203 of switching display of the target game scene region to display of the game scene global map in response to the exit trigger operation for the target game scene region may include:
in response to the exit trigger operation for a currently displayed target game scene region of the target game scene regions, in response to determining that the currently displayed target game scene region corresponds to the last selected target scene regional map based on the selection order, switching display of the currently displayed target game scene region to display of the game scene global map.

In addition, in response to determining that the currently displayed target game scene region does not correspond to the last selected target scene regional map, switching display of the currently displayed target game scene region to display of one of the target game scene regions next to the currently displayed target game scene region based on the selection order.

Any combination of the above technical solutions may be used to form an alternative embodiment of the present disclosure, and details are not described herein.

According to the method for controlling the game scene provided in the embodiments of the present disclosure, when a player starts a target game, the computer device first displays a game scene global map of the target game. When the player wants to enter a certain region included in the game scene global map to perform a game behaviour, the player may perform an entry trigger operation on a target scene regional map in a plurality of scene regional maps, and the computer device displays a target game scene region corresponding to the target scene regional map. When the player performs an exit trigger operation, the computer device switches the target game scene region to the game scene global map. By displaying the game scene global map and the target game scene region of a small area of the target game, an overall element of the game scene global map is displayed macroscopically and a detail element of a specific game scene region is displayed microscopically in a game process, which improves balance and overall consideration capabilities of the computer device for an artistic effect and display performance and efficiency of large-world maps and reduces an amount of a content displayed by the computer device and a computing power load of the computer device.

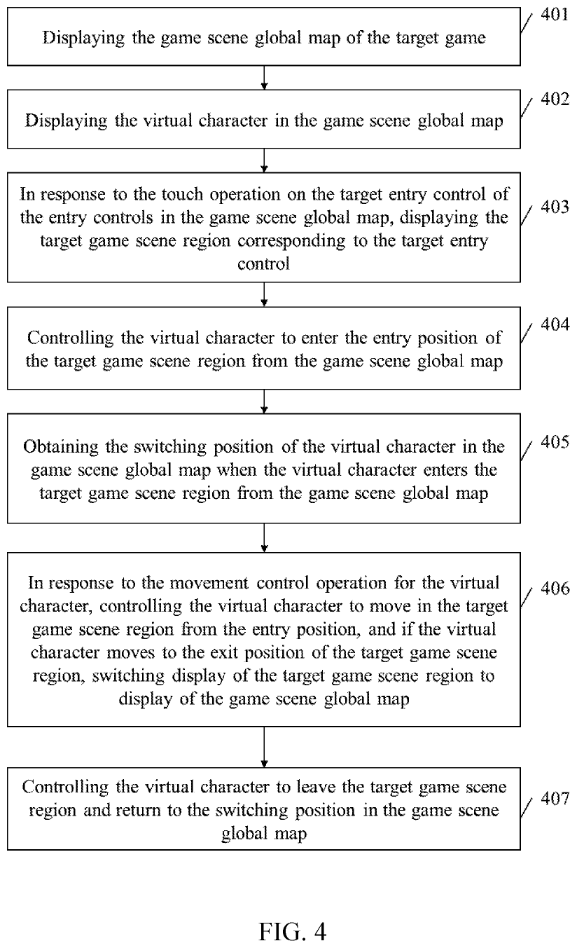

Referring to FIG. 4, FIG. 4 is another schematic flow chart of a method for controlling a game scene according to one or more embodiments of the present disclosure. A specific flow the method may be as below.

In operation 401, the game scene global map of the target game is displayed.

For example, the game scene global map includes the plurality of scene regional maps respectively corresponding to a plurality of game scene regions of the target game.

In operation 402, the current virtual character is displayed in the game scene global map.

In operation 403, in response to the touch operation on the target entry control of the entry controls in the game scene global map, the target game scene region corresponding to the target entry control is displayed.

In the embodiments of the present disclosure, the game scene global map includes the plurality of entry controls respectively corresponding to the game scene regional maps. In response to the touch operation for the target entry control in the entry controls, the game scene regional map corresponding to the target entry control is determined from the plurality of scene regional maps as the target scene regional map; and the target game scene region corresponding to the target scene regional map is obtained and is displayed.

In operation 404, the current virtual character is controlled to enter the target game scene region from the game scene global map position.

For example, the current virtual character is controlled to perform the game behaviour from the entry position in the target game scene region.

In operation 405, the switching position of the current virtual character in the game scene global map when the current virtual character enters the target game scene region from the game scene global map is obtained.

In operation 406, in response to the movement control operation for the current virtual character, if the current virtual character moves to the exit position of the target game scene region, display of the target game scene region is switched to display of the game scene global map.

In operation 407, the current virtual character is controlled to leave the target game scene region and return to the switching position in the game scene global map.

Any combination of the above technical solutions may be used to form an alternative embodiment of the present disclosure, and details are not described herein.

According to the method for controlling the game scene provided in the embodiments of the present disclosure, when a player starts a target game, the computer device first displays a game scene global map of the target game. When the player wants to enter a certain region included in the game scene global map to perform a game behaviour, the player may perform an entry trigger operation on a target scene regional map in a plurality of scene regional maps, and the computer device displays a target game scene region corresponding to the target scene regional map. When the player performs an exit trigger operation, the computer device switches the target game scene region to the game scene global map. By displaying the game scene global map and the target game scene region of a small area of the target game, an overall element of the game scene global map is displayed macroscopically and a detail element of a specific game scene region is displayed microscopically in a game process, which improves balance and overall consideration capabilities of the computer device for an artistic effect and display performance and efficiency of large-world maps and reduces an amount of a content displayed by the computer device and a computing power load of the computer device.

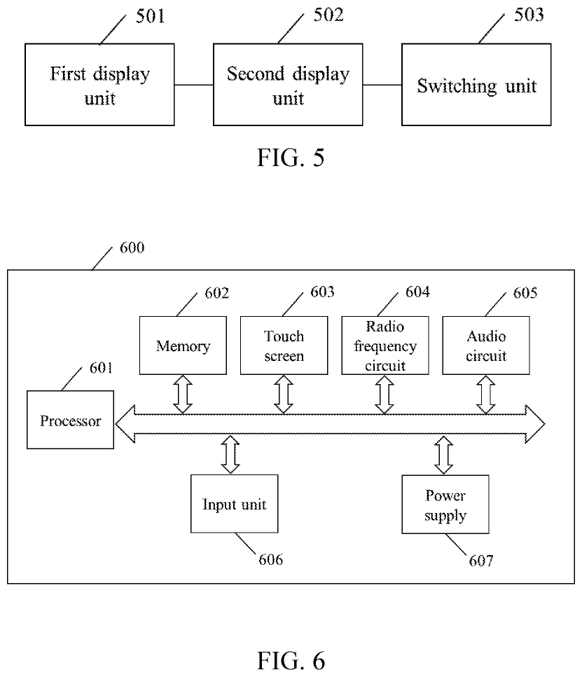

To facilitate better implementation of the method for controlling the game scene of the embodiments of the present disclosure, the embodiments of the present disclosure further provide an apparatus for controlling a game scene. Referring to FIG. 5, FIG. 5 is a schematic structural diagram illustrating an apparatus for controlling a game scene according to one or more embodiments of the present disclosure. The apparatus for controlling the game scene may include a first display unit 501, a second display unit 502, and a switching unit 503.

The first display unit 501 is configured to display a game scene global map of a target game, the game scene global map comprising a plurality of scene regional maps, wherein one of the scene regional maps corresponds to a game scene region of the target game.

The second display unit 502 is configured to display a target game scene region of one or more target game scene regions of the game scene regions corresponding to a target scene regional map of one or more target scene regional maps of the scene regional maps, in response to an entry trigger operation for the target scene regional map of the scene regional maps, wherein after entering the target scene regional, a current virtual character controlled by a player performs game behaviour in the target scene regional map.

The switching unit 503 is configured to switch display of the target game scene region to display of the game scene global map, in response to an exit trigger operation for the target game scene region.

Optionally, the game scene global map includes a plurality of entry controls respectively corresponding to the game scene regional maps. The second display unit 502 is further configured to:
determine a scene regional map of the scene regional maps corresponding to a target entry control as the target scene regional map, in response to a touch operation on the target entry control of the entry controls; and
obtain the target game scene region corresponding to the target scene regional map, and displaying the target game scene region.

Optionally, the first display unit 501 is further configured to:
display the current virtual character in the game scene global map.

The second display unit 502 is further configured to:
control the current virtual character to enter the target game scene region from the game scene global map, and
control the current virtual character to perform the game behaviour in the target game scene region.

Optionally, the switching unit 503 is further configured to:
switch display of the target game scene region to display of the game scene global map, and control the current virtual character to leave the target game scene region and return to the game scene global map, in response to the exit trigger operation for the target game scene region.

Optionally, the second display unit 502 is further configured to:
obtain a switching position of the current virtual character in the game scene global map when entering the target game scene region from the game scene global map.

The switching unit 503 is further configured to:
control the current virtual character to leave the target game scene region and return to the switching position in the game scene global map.

Optionally, the target game scene region includes an entry position and an exit position.

The second display unit 502 is further configured to:
after entering the target game scene region, control the current virtual character to be located at the entry position of the target game scene region; and
in response to a movement control operation for the current virtual character, control the current virtual character to move in the target game scene region from the entry position of the one of the target game scene regions.

The switching unit 503 is further configured to:
in response to the movement control operation for the current virtual character, if the current virtual character moves to the exit position, switching display of the target game scene region to display of the game scene global map.

Optionally, the second display unit 502 is further configured to:
control the current virtual character to enter the target game scene region; and
in response to a game fight joining operation for the current virtual character in the target game scene region, control the current virtual character to join a game fight in the target game scene region.

The switching unit 503 is further configured to:
in response to a game operation for the current virtual character in the game fight, if the game fight ends, switching display of the target game scene region to display of the game scene global map.

Optionally, the second display unit 502 is further configured to:
obtain region attribute information of each of the scene regional maps in the game scene global map; and
display the region attribute information corresponding to the each of the scene regional maps in a preset range of each of the scene regional maps in the game scene global map.

Optionally, the second display unit 502 is further configured to:
in response to selection operations respectively for the target scene regional maps in the game scene global map, determine a selection order in which the target scene regional maps are selected, as an order in which the current virtual character is to enter the target game scene regions; and
switch display of the game scene global map to display of the target game scene region corresponding to the first selected target scene regional map in the selection order.

The switching unit 503 is further configured to:
in response to the exit trigger operation for a currently displayed target game scene region of the target game scene regions, in response to determining that the currently displayed target game scene region corresponds to the last selected target scene regional map based on the selection order, switch display of the currently displayed target game scene region to display of the game scene global map; and
in response to determining that the currently displayed target game scene region does not correspond to the last selected target scene regional map, switch display of the currently displayed target game scene region to display of one of the target game scene regions next to the currently displayed target game scene region based on the selection order.

Optionally, the game scene global map includes a global map element, the game scene region includes a regional map element, the global map element includes a reference map element corresponding to the regional map element, and a position of the reference map element in the game scene global map is used to represent a position of the regional map element in the game scene region.

Optionally, the game scene global map includes a satellite map of all game scenes of the target game.

Any combination of the above technical solutions may be used to form an alternative embodiment of the present disclosure, and details are not described herein.

According to the apparatus for controlling the game scene provided in the embodiments of the present disclosure, when a player starts a target game, the computer device first displays a game scene global map of the target game. When the player wants to enter a certain region included in the game scene global map to perform a game behaviour, the player may perform an entry trigger operation on a target scene regional map in a plurality of scene regional maps, and the computer device displays a target game scene region corresponding to the target scene regional map. When the player performs an exit trigger operation, the computer device switches the target game scene region to the game scene global map. By displaying the game scene global map and the target game scene region of a small area of the target game, an overall element of the game scene global map is displayed macroscopically and a detail element of a specific game scene region is displayed microscopically in a game process, which improves balance and overall consideration capabilities of the computer device for an artistic effect and display performance and efficiency of large-world maps and reduces an amount of a content displayed by the computer device and a computing power load of the computer device.

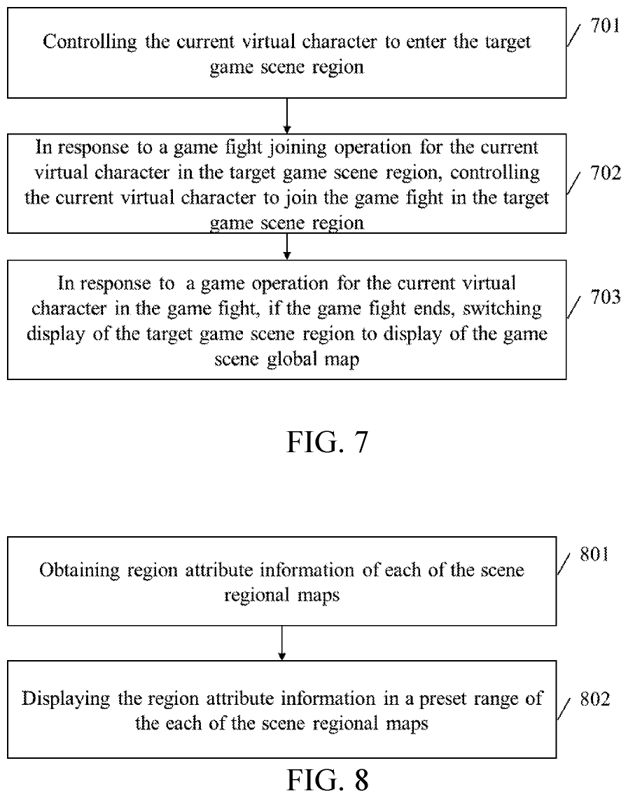

Accordingly, the embodiments of the present disclosure further provide a computer device, which may be a terminal. The terminal may be a terminal device such as a smartphone, a tablet computer, a notebook computer, a touch screen, a game machine, a personal computer, or a personal digital assistant. As shown in FIG. 6, FIG. 6 is a schematic structural diagram illustrating a computer device according to one or more embodiments of the present disclosure. The computer device 600 includes a processor 601 having one or more processing cores, a memory 602 having one or more computer-readable storage media, and a computer program stored on the memory 602 and operable on the processor. The processor 601 is electrically connected to the memory 602. It will be appreciated by those skilled in the art that a computer device structure illustrated in the figure does not constitute a limitation on the computer device, and may include more or less components than illustrated, or may combine some components, or has different component arrangements.

The processor 601 is a control centre of the computer device 600, connects various parts of the computer device 600 by various interfaces and lines, and performs various functions of the computer device 600 and processes data by running or loading software programs and/or modules stored in the memory 602 and invoking data stored in the memory 602, thereby monitoring the computer device 600 as a whole.

In the embodiments of the present disclosure, the processor 601 in the computer device 600 loads instructions corresponding to processes of one or more application programs into the memory 602 according to the following operations, and runs the application programs stored in the memory 602 to implement various functions:
displaying a game scene global map of a target game, the game scene global map comprising a plurality of scene regional maps, wherein one of the scene regional maps corresponds to a game scene region of the target game;
displaying a target game scene region of one or more target game scene regions of the game scene regions corresponding to a target scene regional map of one or more target scene regional maps of the scene regional maps, in response to an entry trigger operation for the target scene regional map of the scene regional maps, wherein after entering the target scene regional, a current virtual character controlled by a player performs game behaviour in the target scene regional map; and
switching display of the target game scene region to display of the game scene global map, in response to an exit trigger operation for the target game scene region.

Optionally, the game scene global map includes a plurality of entry controls respectively corresponding to the game scene regional maps. Displaying the target game scene regions of the game scene regions respectively corresponding to the target scene regional maps in response to the entry trigger operation for the target scene regional maps of the scene regional maps includes:
determining a scene regional map of the scene regional maps corresponding to a target entry control as the target scene regional map, in response to a touch operation on the target entry control of the entry controls; and
obtaining the target game scene region corresponding to the target scene regional map, and displaying the target game scene region.

Optionally, after displaying the game scene global map of the target game, the operations further include:
displaying the current virtual character in the game scene global map.

After displaying the target game scene region of the one or more target game scene regions of the game scene regions corresponding to the target scene regional map of the one or more target scene regional maps in response to the entry trigger operation for the target scene regional map of the scene regional maps, the operations further include:
controlling the current virtual character to enter the target game scene region from the game scene global map, and
controlling the current virtual character to perform the game behaviour in the target game scene region.

Optionally, the switching display of the target game scene region to display of the game scene global map in response to the exit trigger operation for the target game scene region includes:
switching display of the target game scene region to display of the game scene global map, and controlling the current virtual character to leave the target game scene region and return to the game scene global map, in response to the exit trigger operation for the target game scene region.

Optionally, after controlling the current virtual character to enter the target game scene region from the game scene global map, the operations further include:
obtaining a switching position of the current virtual character in the game scene global map when entering the target game scene region from the game scene global map.

The controlling the current virtual character to leave the target game scene regions and return to the game scene global map includes:
controlling the current virtual character to leave the target game scene region and return to the switching position in the game scene global map.

Optionally, the target game scene region has an entry position and an exit position. After displaying the target game scene region of the one or more target game scene regions of the game scene regions corresponding to the target scene regional map of the one or more target scene regional maps of the scene regional maps in response to the entry trigger operation for the target scene regional map of the scene regional maps, the operations further include:
after entering the target game scene region, controlling the current virtual character to be located at the entry position of the target game scene region; and
in response to the movement control operation for the current virtual character, if the current virtual character moves to the exit position, switching display of the target game scene region to display of the game scene global map.

The switching display of the target game scene region to display of the game scene global map in response to the exit trigger operation for the target game scene region includes:
in response to the movement control operation for the current virtual character, if the current virtual character moves to the exit position, switching display of the target game scene region to display of the game scene global map.

Optionally, after displaying the target game scene region of the one or more target game scene regions of the game scene regions corresponding to the target scene regional map of the one or more target scene regional maps of the scene regional maps in response to the entry trigger operation for the target scene regional map of the scene regional maps, the operations further include:
controlling the current virtual character to enter the target game scene region; and
in response to a game fight joining operation for the current virtual character in the target game scene region, controlling the current virtual character to join a game fight in the target game scene region.

The switching display of the target game scene region to display of the game scene global map in response to the exit trigger operation for the target game scene region includes:
in response to a game operation for the current virtual character in the game fight, if the game fight ends, switching display of the target game scene region to display of the game scene global map.

Optionally, before displaying the target game scene region of the one or more target game scene regions of the game scene regions corresponding to the target scene regional map of the one or more target scene regional maps of the scene regional maps in response to the entry trigger operation for the target scene regional map of the scene regional maps, the operations further include:
obtaining region attribute information of each of the scene regional maps in the game scene global map; and
displaying the region attribute information corresponding to the each of the scene regional maps in a preset range of each of the scene regional maps in the game scene global map.

Optionally, the displaying the target game scene region of the one or more target game scene regions of the game scene regions corresponding to the target scene regional map of the one or more target scene regional maps of the scene regional maps in response to the entry trigger operation for the target scene regional map of the scene regional maps includes:
in response to selection operations respectively for the target scene regional maps in the game scene global map, determining a selection order in which the target scene regional maps are selected, as an order in which the current virtual character is to enter the target game scene regions; and
switching display of the game scene global map to display of the target game scene region corresponding to the first selected target scene regional map in the selection order.

The switching display of the target game scene region to display of the game scene global map in response to the exit trigger operation for the target game scene regions includes:
in response to the exit trigger operation for a currently displayed target game scene region of the target game scene regions, in response to determining that the currently displayed target game scene region corresponds to the last selected target scene regional map based on the selection order, switching display of the currently displayed target game scene region to display of the game scene global map.

The method further include:
in response to determining that the currently displayed target game scene region does not correspond to the last selected target scene regional maps, switching display of the currently displayed target game scene region to display of one of the target game scene regions next to the currently displayed target game scene region based on the selection order.

Optionally, the game scene global map includes a global map element, the game scene region includes a regional map element, the global map element includes a reference map element corresponding to the regional map element, and a position of the reference map element in the game scene global map is used to represent a position of the regional map element in the game scene region.

Optionally, the game scene global map includes a satellite map of all game scenes of the target game.

Embodiments of the present disclosure disclose methods for controlling a game scene, apparatuses, computer devices, and storage media. The method includes: displaying a game scene global map of a target game, the game scene global map including a plurality of scene regional maps, wherein one of the scene regional maps corresponds to a game scene region of the target game; displaying a target game scene region of one or more target game scene regions of the game scene regions corresponding to a target scene regional map of one or more target scene regional maps of the scene regional maps, in response to an entry trigger operation for the target scene regional map of the scene regional maps, wherein after entering the target scene regional, a current virtual character controlled by a player performs game behaviour in the target scene regional map; and switching display of the target game scene region to display of the game scene global map, in response to an exit trigger operation for the target game scene region. An amount of a content displayed by a computer device and a computing power load are reduced.

Detailed implementation of the above operations may be referred to aforementioned embodiments, and will not be repeated herein.

Optionally, as shown in FIG. 6, the computer device 600 further includes a touch screen 603, a radio frequency circuit 604, an audio circuit 605, an input unit 606, and a power supply 607. The processor 601 is electrically connected to the touch screen 603, the radio frequency circuit 604, the audio circuit 605, the input unit 606, and the power supply 607, respectively. It will be appreciated by those skilled in the art that the computer device structure shown in FIG. 6 does not constitute a limitation on the computer device, and may include more or fewer components than illustrated, or may combine some components, or has different component arrangements.

The touch screen 603 may be configured to display a graphical user interface and to receive operational instructions generated by a user acting on the graphical user interface. The touch display screen 603 may include a display panel and a touch panel. The display panel may be used to display information input by or provided to the user and various graphical user interfaces of the computer device, which may be composed of graphics, text, icons, videos, and any combination thereof. Alternatively, the display panel may be configured in a form of a Liquid Crystal Display (LCD), an Organic Light-Emitting Diode (OLED), or the like. The touch panel may be used to collect a touch operation (e.g., an operation of the user on or near the touch panel using any suitable object or accessory such as a finger, a stylus, etc.) of the user on or near the touch panel, and generate a corresponding operation instruction, and the operation instruction executes a corresponding program. Alternatively, the touch panel may include a touch detection device and a touch controller. The touch detection device detects a touch orientation of the user, detects a signal brought about by the touch operation, and transmits the signal to the touch controller. The touch controller receives touch information from the touch detection device and converts the touch information into contact coordinates, sends the contact coordinates to the processor 601, and can receive and execute commands sent from the processor 601. The touch panel may cover the display panel, and when the touch panel detects the touch operation on or near the touch panel, the touch panel transmits the touch operation to the processor 601 to determine a type of a touch event. Then, the processor 601 provides a corresponding visual output on the display panel according to the type of the touch event. In the embodiments of the present disclosure, the touch panel and the display panel may be integrated to the touch screen 603 to implement input and output functions. However, in one or more embodiments, the touch panel and the touch panel may be implemented as two separate components to implement the input and output functions. That is, the touch screen 603 may implement the input function as part of the input unit 606.

The radio frequency circuit 604 may be configured to transmit and receive radio frequency signals to establish wireless communication with a network device or other computer devices through wireless communication, and to transmit and receive signals between the network device or other computer devices.

The audio circuit 605 may be configured to provide an audio interface between the user and the computer device through a speaker and a microphone. The audio circuit 605 may transmit an electrical signal converted from received audio data to a loudspeaker, and the loudspeaker converts the electrical signal into a sound signal for output. On the other hand, the microphone converts a collected sound signal into an electrical signal, the audio circuit 605 receives and converts the electrical signal into audio data. The audio data is outputted to the processor 601 for processing, and the processed audio data is sent to, for example, another computer device through the radio frequency circuit 604, or the audio data is outputted to the memory 602 for further processing. The audio circuit 605 may also include an earplug jack to provide communication between a peripheral headset and the computer device.

The input unit 606 may be configured to receive input numbers, character information, or user characteristic information (e.g., fingerprints, iris, face information), and to generate keyboard, mouse, joystick, optical, or trackball signal input related to user settings and functional control.

The power supply 607 is configured to power various components of the computer device 600. Alternatively, the power supply 607 may be logically connected to the processor 601 through a power supply management system, so that functions such as charging, discharging, and power consumption management are managed through the power supply management system. The power supply 607 may further include one or more DC or AC power supplies, a recharging system, a power failure detection circuit, a power converter or inverter, a power status indicator, or any other component.

Although not shown in FIG. 6, the computer device 600 may also include a camera, a sensor, a wireless fidelity module, a Bluetooth module, and the like, and details are not described herein.

In the above-mentioned embodiments, the description of each embodiment has its own emphasis, and parts not described in detail in a certain embodiment may be referred to related description of other embodiments.

As can be seen from the above, according to the computer device provided in the embodiment, when a player starts a target game, the computer device first displays a game scene global map of the target game. When the player wants to enter a certain region included in the game scene global map to perform a game behaviour, the player may perform an entry trigger operation on a target scene regional map in a plurality of scene regional maps, and the computer device displays a target game scene region corresponding to the target scene regional map. When the player performs an exit trigger operation, the computer device switches the target game scene region to the game scene global map. By displaying the game scene global map and the target game scene region of a small area of the target game, an overall element of the game scene global map is displayed macroscopically and a detail element of a specific game scene region is displayed microscopically in a game process, which improves balance and overall consideration capabilities of the computer device for an artistic effect and display performance and efficiency of large-world maps and reduces an amount of a content displayed by the computer device and a computing power load of the computer device.

It will be appreciated by those of ordinary skill in the art that all or a portion of the operations of the various methods of the above-described embodiments may be performed by instructions, which may be stored in a computer-readable storage medium and loaded and executed by a processor, or may be performed by the instructions through controlling relevant hardware.

To this end, the embodiments of the present disclosure provide a computer-readable storage medium having stored therein a plurality of computer programs. The computer programs can be loaded by a processor to perform operations in any of the method(s) for controlling the game scene provided in the embodiments of the present disclosure. For example, the computer programs may perform the following operations:
displaying a game scene global map of a target game, the game scene global map comprising a plurality of scene regional maps, wherein one of the scene regional maps corresponds to a game scene region of the target game;
displaying a target game scene region of one or more target game scene regions of the game scene regions corresponding to a target scene regional map of one or more target scene regional maps of the scene regional maps, in response to an entry trigger operation for the target scene regional map of the scene regional maps, wherein after entering the target scene regional, a current virtual character controlled by a player performs game behaviour in the target scene regional map; and
switching display of the target game scene region to display of the game scene global map, in response to an exit trigger operation for the target game scene region.

Optionally, the game scene global map includes a plurality of entry controls respectively corresponding to the scene regional maps. The displaying the target game scene region of the one or more target game scene regions of the game scene regions corresponding to the target scene regional map of the one or more target scene regional maps of the scene regional maps in response to the entry trigger operation for the target scene regional map of the scene regional maps includes:
determining a scene regional map of the scene regional maps corresponding to a target entry control as the target scene regional map, in response to a touch operation on the target entry control of the entry controls; and
obtaining the target game scene region corresponding to the target scene regional map, and displaying the target game scene region.

Optionally, after displaying the game scene global map of the target game, the method further includes:
displaying the current virtual character in the game scene global map.

After displaying the target game scene region of the one or more target game scene regions of the game scene regions corresponding to the target scene regional map of the one or more target scene regional maps in response to the entry trigger operation for the target scene regional map of the scene regional maps, the method further includes:
controlling the current virtual character to enter the target game scene region from the game scene global map, and
controlling the current virtual character to perform the game behaviour in the target game scene region.

Optionally, the switching display of the target game scene region to display of the game scene global map in response to the exit trigger operation for the target game scene region includes:
switching display of the target game scene region to display of the game scene global map, and controlling the current virtual character to leave the target game scene region and return to the game scene global map, in response to the exit trigger operation for the target game scene region.

Optionally, after controlling the current virtual character to enter the target game scene region from the game scene global map, the method further includes:
obtaining a switching position of the current virtual character in the game scene global map when the current virtual character entering the target game scene region from the game scene global map.

The controlling the current virtual character to leave the target game scene region and return to the game scene global map includes:
controlling the current virtual character to leave the target game scene region and return to the switching position in the game scene global map.

Optionally, the target game scene region has an entry position and an exit position. After displaying the target game scene region of the one or more target game scene regions of the game scene regions corresponding to the target scene regional map of the one or more target scene regional maps of the scene regional maps in response to the entry trigger operation for the target scene regional map of the scene regional maps, the method further includes:
after entering the target game scene region, controlling the current virtual character to be located at the entry position of the target game scene region; and
in response to a movement control operation for the current virtual character, controlling the current virtual character to move in the target game scene region from the entry position of the target game scene region.

The switching display of the target game scene region to display of the game scene global map in response to the exit trigger operation for the target game scene region includes:
in response to the movement control operation for the current virtual character, if the current virtual character moves to the exit position, switching display of the target game scene region to display of the game scene global map.

Optionally, after displaying the target game scene region of the one or more target game scene regions of the game scene regions corresponding to the target scene regional map of the one or more target scene regional maps of the scene regional maps in response to the entry trigger operation for the target scene regional map of the scene regional maps, the method further includes:
controlling the current virtual character to enter the target game scene region; and
in response to a game fight joining operation for the current virtual character in the target game scene region, controlling the current virtual character to join a game fight in the target game scene region.

The switching display of the target game scene region to display of the game scene global map in response to the exit trigger operation for the target game scene region includes:
in response to a game operation for the current virtual character in the game fight, if the game fight ends, switching display of the target game scene region to display of the game scene global map.

Optionally, before displaying the target game scene region of the one or more target game scene regions of the game scene regions corresponding to the target scene regional map of the one or more target scene regional maps of the scene regional maps in response to the entry trigger operation for the target scene regional map of the scene regional maps, the method further includes:
obtaining region attribute information of each of the scene regional maps in the game scene global map; and
displaying the region attribute information corresponding to each of the scene regional maps in a preset range of the each of the scene regional maps in the game scene global map.

Optionally, the displaying the target game scene region of the one or more target game scene regions of the game scene regions corresponding to the target scene regional map of the one or more target scene regional maps of the scene regional maps in response to the entry trigger operation for the target scene regional map of the scene regional maps includes:
in response to selection operations respectively for the target scene regional maps in the game scene global map, determining a selection order in which the target scene regional maps are selected, as an order in which the current virtual character is to enter the target game scene regions; and
switching display of the game scene global map to display of one of the target game scene regions corresponding to the first selected target scene regional map in the selection order.

The switching display of the target game scene region to display of the game scene global map in response to the exit trigger operation for the target game scene region includes:
in response to the exit trigger operation for a currently displayed target game scene region of the target game scene regions, in response to determining that the currently displayed target game scene region corresponds to the last selected target scene regional map based on the selection order, switching display of the currently displayed target game scene region to display of the game scene global map.

The method further includes:
in response to determining that the currently displayed target game scene region does not correspond to the last selected target scene regional map, switching display of the currently displayed target game scene region to display of one of the target game scene regions next to the currently displayed target game scene region based on the selection order.

Optionally, the game scene global map includes a global map element, the game scene region includes a regional map element, the global map element includes a reference map element corresponding to the regional map element, and a position of the reference map element in the game scene global map is used to represent a position of the regional map element in the game scene region.

Optionally, the game scene global map includes a satellite map of all game scenes of the target game.

Embodiments of the present disclosure discloses methods for controlling a game scene, apparatuses, computer devices, and storage media. The method includes: displaying a game scene global map of a target game, the game scene global map including a plurality of scene regional maps respectively corresponding to a plurality of game scene regions of the target game; in response to an entry trigger operation for one or more target scene regional maps of the scene regional maps, displaying one or more target game scene regions of the game scene regions respectively corresponding to the one or more target scene regional maps, wherein after entering the target game scene region, a current virtual character controlled by a player performs a game behaviour in the target game scene region; and in response to an exit trigger operation for the target game scene regions, switching display of the target game scene regions to display of the game scene global map. An amount of a content displayed by a computer device and a computing power load are reduced.

Detailed implementation of the above operations may be referred to aforementioned embodiments, and will not be repeated herein.

The storage medium may include a Read Only Memory (ROM), a Random Access Memory (RAM), a magnetic disk, an optical disk, or the like.

Due to the computer programs stored in the storage medium, the operations in any of the methods for controlling the game scene provided in the embodiments of the present disclosure may be executed. Thus, advantageous effects that can be achieved in any one of the methods for controlling the game scene provided in the embodiments of the present disclosure can be realized. Details may be referred to the foregoing embodiments, which are not described herein.

In the above-mentioned embodiments, the description of each embodiment has its own emphasis. For parts not described in detail in a certain embodiment, related description of other embodiments may be referred to.

The methods for controlling a game scene, apparatuses, computer devices, and computer-readable storage media provided in the embodiments of the present disclosure are introduced in detail, and the principles and embodiments of the present disclosure are described herein using specific examples. The description of the above embodiments merely aims to help to understand the technical solutions and the core concept of the present disclosure. It will be appreciated by those of ordinary skill in the art that modifications may still be made to the technical solutions described in the foregoing embodiments, or equivalents may be made to some of the technical features therein. However, these modifications or equivalents do not depart the essence of the corresponding technical solutions from the scope of the technical solutions of the embodiments of the present disclosure.

1. A method for controlling a game scene, comprising:
displaying a game scene global map of a target game, the game scene global map comprising a plurality of scene regional maps, wherein one of the scene regional maps corresponds to a game scene region of the target game;
displaying a target game scene region of one or more target game scene regions of the game scene regions corresponding to a target scene regional map of one or more target scene regional maps of the scene regional maps, in response to an entry trigger operation for the target scene regional map of the scene regional maps, wherein after entering the target scene regional, a current virtual character controlled by a player performs game behaviour in the target scene regional map; and
switching display of the target game scene region to display of the game scene global map, in response to an exit trigger operation for the target game scene region.

2. The method according to claim 1, wherein the game scene global map further comprises a plurality of entry controls respectively corresponding to the scene regional maps; and
the displaying the target game scene region of the one or more target game scene regions of the game scene regions corresponding to the target scene regional map of the one or more target scene regional maps of the scene regional maps in response to the entry trigger operation for the target scene regional map of the scene regional maps, comprises:
determining a scene regional map of the scene regional maps corresponding to a target entry control as the target scene regional map, in response to a touch operation on the target entry control of the entry controls; and
obtaining the target game scene region corresponding to the target scene regional map, and displaying the target game scene region.

3. The method according to claim 1, further comprising:
displaying the current virtual character in the game scene global map; and
wherein after displaying the target game scene region of the one or more target game scene regions of the game scene regions corresponding to the target scene regional map of the one or more target scene regional maps in response to the entry trigger operation for the target scene regional map of the scene regional maps, the method further comprises:
controlling the current virtual character to enter the target game scene region from the game scene global map
for performing the game behaviour in the target game scene region.

4. The method according to claim 3, wherein the switching display of the target game scene region to display of the game scene global map in response to the exit trigger operation for the target game scene region, comprises:
switching display of the target game scene region to display of the game scene global map, and controlling the current virtual character to leave the target game scene region and return to the game scene global map, in response to the exit trigger operation for the target game scene region.

5. The method according to claim 4, further comprising:
after controlling the current virtual character to enter the target game scene region from the game scene global map, obtaining a switching position of the current virtual character in the game scene global map when entering the target game scene region from the game scene global map,
wherein the controlling the current virtual character to leave the target game scene region and return to the game scene global map comprises:
controlling the current virtual character to leave the target game scene region and return to the switching position in the game scene global map.

6. The method according to claim 1, wherein the target game scene region has an entry position and an exit position;
the method further comprises:
after displaying the target game scene region of the one or more target game scene regions of the game scene regions corresponding to the target scene regional map of the one or more target scene regional maps of the scene regional maps in response to the entry trigger operation for the target scene regional map of the scene regional maps, after entering the target game scene region, controlling the current virtual character to be located at the entry position of the target game scene region and,
in response to a movement control operation for the current virtual character, controlling the current virtual character to move in the target game scene region from the entry position of the target game scene region; and
the switching display of the target game scene region to display of the game scene global map in response to the exit trigger operation for the target game scene region, comprises:
in response to the movement control operation for the current virtual character, if the current virtual character moves to the exit position, switching display of the target game scene region to display of the game scene global map.

7. The method according to claim 1, further comprising:
after displaying the target game scene region of the one or more target game scene regions of the game scene regions corresponding to the target scene regional map of the one or more target scene regional maps of the scene regional maps in response to the entry trigger operation for the target scene regional map of the scene regional maps,
controlling the current virtual character to enter the target game scene region; and
in response to a game fight joining operation for the current virtual character in the target game scene region, controlling the current virtual character to join a game fight in the target game scene region,
wherein the switching of display of the target game scene region to display of the game scene global map in response to the exit trigger operation for the target game scene region comprises:
in response to a game operation for the current virtual character in the game fight, if the game fight ends, switching display of the target game scene region to display of the game scene global map.

8. The method according to claim 1, further comprising:
before displaying the target game scene region of the one or more target game scene regions of the game scene regions corresponding to the target scene regional map of the one or more target scene regional maps of the scene regional maps in response to the entry trigger operation for the target scene regional map of the scene regional maps,
obtaining region attribute information of each of the scene regional maps in the game scene global map; and
displaying the region attribute information corresponding to each of the scene regional maps in a preset range of the each of the scene regional maps in the game scene global map.

9. The method according to claim 1, wherein the displaying the target game scene region of the one or more target game scene regions of the game scene regions corresponding to the target scene regional map of the one or more target scene regional maps of the scene regional maps in response to the entry trigger operation for the target scene regional map of the scene regional maps, comprises:
in response to selection operations respectively for the target scene regional maps in the game scene global map, determining a selection order in which the target scene regional maps are selected, as an order in which the current virtual character enter the target game scene regions; and
switching display of the game scene global map to display of one of the target game scene regions corresponding to the first selected target scene regional map in the selection order;
the switching of display of the target game scene region to display of the game scene global map in response to the exit trigger operation for the target game scene region, comprises:
in response to the exit trigger operation for a currently displayed target game scene region of the target game scene regions, in response to determining that the currently displayed target game scene region corresponds to the last selected target scene regional map based on the selection order, switching display of the currently displayed target game scene region to display of the game scene global map;
the method further comprises:
in response to the exit trigger operation for the currently displayed target game scene region, in response to determining that the currently displayed target game scene region does not correspond to the last selected target scene regional map, switching display of the currently displayed target game scene region to display of one of the target game scene regions next to the currently displayed target game scene region based on the selection order.

10. The method according to claim 1, wherein the game scene global map comprises a global map element, the game scene region comprises a regional map element, the global map element comprises a reference map element corresponding to the regional map element, and a position of the reference map element in the game scene global map is used to represent a position of the regional map element in the game scene region.

11. The method according to claim 1, wherein the game scene global map comprises a satellite map of all game scenes of the target game.

12. (canceled)

13. A computer device, comprising:
a memory, configured to store computer programs; and
a processor, configured to execute the computer programs to perform operations of:
displaying a game scene global map of a target game, the game scene global map comprising a plurality of scene regional maps, wherein one of the scene regional maps corresponds to a game scene region of the target game;
displaying a target game scene region of one or more target game scene regions of the game scene regions corresponding to a target scene regional map of one or more target scene regional maps of the scene regional maps, in response to an entry trigger operation for the target scene regional map of the scene regional maps, wherein after entering the target scene regional, a current virtual character controlled by a player performs game behaviour in the target scene regional map; and
switching display of the target game scene region to display of the game scene global map, in response to an exit trigger operation for the target game scene region.

14. A non-transitory computer-readable storage medium storing computer programs executed by a processor to perform operations of:
displaying a game scene global map of a target game, the game scene global map comprising a plurality of scene regional maps, wherein one of the scene regional maps respectively corresponds to a game scene region of the target game;
displaying a target game scene region of one or more target game scene regions of the game scene regions corresponding to a target scene regional map of one or more target scene regional maps of the scene regional maps, in response to an entry trigger operation for the target scene regional map of the scene regional maps, wherein after entering the target scene regional, a current virtual character controlled by a player performs game behaviour in the target scene regional map; and
switching display of the target game scene region to display of the game scene global map, in response to an exit trigger operation for the target game scene region.

15-20. (canceled)

21. The method according to claim 1, wherein the game scene global map shows an outline of a virtual object.

22. The method according to claim 1, wherein the game scene global map comprises all of one or more regions of a virtual scene of the target game.

23. The method according to claim 1, wherein a scene regional map of the scene regional maps refers to a scene map of a partial region in the game scene global map.

24. The method according to claim 1, wherein the game scene region refers to a specific virtual game scene corresponding to the one of the scene regional maps.

25. The method according to claim 1, wherein the game scene region shows a virtual object with a definition greater than a threshold.

26. The method according to claim 3, wherein the method further comprises: controlling the current virtual character to move in the game scene global map.

27. The method according to claim 1, further comprising:
after displaying the target game scene region of the one or more target game scene regions of the game scene regions corresponding to the target scene regional map of the one or more target scene regional maps of the scene regional maps in response to the entry trigger operation for the target scene regional map of the scene regional maps, after the current virtual character enters the target game scene region, determining whether the current virtual character satisfies a preset game behaviour condition;
wherein the switching display of the target game scene region to display of the game scene global map in response to the exit trigger operation for the target game scene region comprises:
in response to the current virtual character satisfying the preset game behaviour condition, in response to the exit trigger operation for the target game scene region, switching display of the target game scene region to display of the game scene global map, and controlling the current character to return to the game scene global map.
